(19) United States
(12) Patent Application Publication
(10) Pub. No.: US 2024/0110077 A1
(43) Pub. Date: Apr. 4, 2024

(54) RESIN COMPOSITION, LAMINATE STRUCTURE, CABLE, TUBE, AND METHOD FOR MANUFACTURING RESIN COMPOSITION

(71) Applicant: Proterial, Ltd., Tokyo (JP)

(72) Inventors: Kanako SUGANUMA, Tokyo (JP); Seiichi KASHIMURA, Tokyo (JP); Hideyuki SUZUKI, Tokyo (JP); Masamichi KISHI, Tokyo (JP); Naoto TERAKI, Tokyo (JP)

(21) Appl. No.: 18/470,213

(22) Filed: Sep. 19, 2023

(30) Foreign Application Priority Data
Sep. 30, 2022 (JP) 2022-157379

(51) Int. Cl. C09D 119/00; C08L 19/00; C09D 7/48

(52) U.S. Cl. CPC C09D 119/00; C08L 19/00; C09D 7/48; C08L 2201/08; C08L 2203/202

(57) ABSTRACT

A resin composition includes silicone rubber as a base material, silicone resin fine particles, metal oxide fine particles, and nanosilica fine particles. A laminate structure includes a first layer including silicone rubber as a base material, and a second layer laminated to the first layer and including the resin composition. A cable or tube is provided with the laminate structure. A method of manufacturing the resin composition includes adding nanosilica fine particles to a mixture of silicone rubber, titanium dioxide fine particles, and an organic solvent, followed by adding silicone resin fine particles.

### CROSS-REFERENCE TO RELATED APPLICATIONS

The present patent application claims the priority of Japanese patent application No. 2022-157379 filed on Sep. 30, 2022, and the entire contents thereof are hereby incorporated by reference.

### TECHNICAL FIELD

This invention relates to a resin composition, a laminate structure, a cable, a tube, and a method for manufacturing the resin composition.

### BACKGROUND OF THE INVENTION

Conventionally, a cable for medical devices made of silicone rubber including fine particles and with a layer that covers a sheath has been known (see Patent Literature 1). Compared with polyvinyl chloride (PVC), which has been commonly used as a material for sheath, silicone rubber has advantages such as little discoloration over time, but it tends to have low surface slidability.

Since a coating film of the cable described in Patent Literature 1 is made of silicone rubber including fine particles, the surface of the cable is formed with irregularities (i.e., unevenness, indentations) derived from fine particles. This uneven surface makes it possible to reduce a contact area when the coating film is in contact with other parts, thereby increasing the slidability of the surface of the layer, i.e., the slidability of the cable.

### CITATION LIST

Patent Literature Patent Literature 1: JP6723489B

### SUMMARY OF THE INVENTION

Recently, as a method of sterilizing medical device cables, a sterilization method by UV-C light, by which the sterilization is easy, inexpensive, and reliable, is attracting attention. However, the resistance of the cable to the UV-C light (Hereinafter referred to as “UV-C resistance”) is a problem in order to perform the sterilization by UV-C light. It has been confirmed that a cable equipped with a sheath made of silicone rubber will deteriorate when the UV-C light is repeatedly irradiated to the cable. Thus, the cable will have cracks in the sheath when stress such as bending the cable is applied to the sheath.

Therefore, in order to provide UV-C resistance in addition to slidability to the cable described in Patent Literature 1, a means of adding metal oxide fine particles that can shield UV-C light to the coating film is considered. However, in this case, in the liquid resin composition that is the raw material of the coating film, the fine particles for forming irregularity on the surface of the coating film such as silicone resin fine particles and the metal oxide fine particles agglomerate and settle, thereby causing separation into a layer consisting mainly of silicone rubber as the base material of the coating film, and a layer consisting mainly of agglomerates.

This causes segregation in the positions of the fine particles for forming irregularity and metallic particles in the resin composition, and segregation in the positions of the fine particles for forming irregularity and metallic particles in the coating film of the cable formed by coating the resin composition, making it difficult to provide the entire cable with slidability and UV-C resistance. In addition, since the separation of the liquid resin composition progresses with the elapse of time, when the resin composition is continuously coated on the cable, the content (i.e., content amount), etc. of the fine particles for forming irregularity and metallic particles in the coating film change depending on the position of the cable. In particular, the content of fine particles for forming irregularity and metallic particles may become insufficient in the part of the coating film formed after a certain amount of time has passed, and the desired slidability and UV-C resistance may not be obtained.

Therefore, it is an object of the present invention to provide a laminate structure with silicone rubber as its base material, which has slidability and UV-C resistance throughout even when manufactured continuously for a long time, a cable and a tube with an insulator made of the laminate structure, a resin composition constituting a surface layer of the laminate structure, and a method for manufacturing the same.

So as to solve the above problems, one aspect of the invention provides a resin composition, comprising: silicone rubber as a base material, silicone resin fine particles, metal oxide fine particles, and nanosilica fine particles.

Further, so as to solve the above problems, another aspect of the invention provides a laminate structure, comprising:
a first layer comprising silicone rubber as a base material; and
a second layer laminated to the first layer, the second layer comprising silicone rubber as a base material, silicone resin fine particles, metal oxide fine particles, and nanosilica fine particles.

Still further, so as to solve the above problems, a further aspect of the invention provides a cable comprising an insulator comprising the laminate structure.

Moreover, so as to solve the above problems, a still further aspect of the invention provides a tube comprising an insulator comprising the laminate structure.

In addition, so as to solve the above problems, yet another aspect of the invention provides a method of manufacturing a resin composition, comprising:
adding nanosilica fine particles to a mixture of silicone rubber, titanium dioxide fine particles, and an organic solvent, followed by adding silicone resin fine particles.

### Advantageous Effects of the Invention

According to the present invention, it is possible to provide a laminate structure with silicone rubber as its base material, which has slidability and UV-C resistance throughout even when manufactured continuously for a long time, a cable and a tube with insulator made of the laminate structure, a resin composition constituting a surface layer of the laminate structure, and a method for manufacturing the same.

### BRIEF DESCRIPTION OF DRAWINGS

FIG. 1 is a vertical cross-sectional view of a laminate structure according to the first embodiment of the present invention.

FIG. 2A is a perspective view of an ultrasonic probe cable according to the second embodiment of the invention.

FIG. 2B is a radial cross-sectional view of a cable of the ultrasonic probe cable taken along a line A-A described in FIG. 2A.

FIG. 3 is a schematic diagram of a coating device used for coating a cable with a coating film.

FIGS. 4A to 4C are radial cross-sectional views of medical tubes according to the second embodiment of the invention, respectively.

FIG. 5 is a photographic image of a screw-tube bottle including sample A1 that was allowed to stand for 120 minutes.

FIG. 6 is a graph showing the change in the width of the separation layer of samples A1 and A4 as a function of the time elapsed since they were placed in a static state.

FIG. 7 is a graph showing the change in the width of the separation layer of samples A4 and A5 as a function of the time elapsed since they were placed in a static state.

FIG. 8 is a schematic diagram of a tuning-fork vibro viscometer used to measure the viscosity of samples A1 to A4.

FIG. 9 is a graph showing viscosity change rate X with respect to measurement time for samples A1 to A4.

FIG. 10 is a graph showing the relationship between the viscosity change rate X of samples A1 to A4 and the concentration of nanosilica fine particles in the second layer formed using samples A1 to A4.

FIG. 11 is a graph showing the relationship between the viscosity of the liquid resin composition and the concentration of nanosilica fine particles in the second layer, obtained by measuring the viscosity of seven samples with different concentrations of nanosilica fine particles.

FIG. 12 shows optical microscope and scanning electron microscope (SEM) images of the surface of the second layer when hydrophilic surface-treated nanosilica fine particles and hydrophobic surface-treated nanosilica fine particles are used.

FIG. 13 is a graph showing the results of tensile tests of samples C1 and C2.

FIG. 14A is a schematic diagram showing the operation of the bending test.

FIG. 14B is a cross-sectional view of a conductor and a test piece (test piece) wrapped around the conductor in the radial direction of the conductor.

FIG. 15 shows the observed images of the surfaces of the test pieces cut from samples C1 and C2, observed with an optical microscope at 50× magnification.

FIG. 16 shows the observed images of the surfaces of test pieces cut from samples C1 and C2, observed with a scanning electron microscope at 500× magnification.

### MODE FOR CARRYING OUT THE INVENTION

### First Embodiment

### (Configuration of the Laminate Structure)

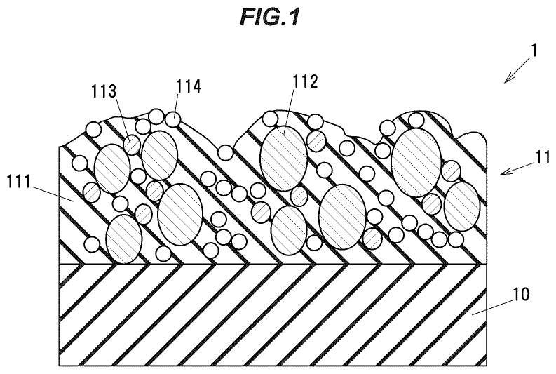

FIG. 1 shows a vertical cross-sectional view of a laminate structure 1 according to the first embodiment of the invention. The laminate structure 1 includes a first layer 10 with silicone rubber as a base material, and a second layer 11 laminated on the first layer 10 with silicone rubber as a base material 111 and including silicone resin fine particles 112, titanium dioxide (TiO₂) fine particles 113, and nanosilica (i.e., nano silica) fine particles 114.

Silicone rubber, the base material of the first layer 10 and the second layer 11, is a kind of silicone resins. Silicone rubber has higher resistance to ultraviolet lights (UV-A light, UV-B light, and UV-C light) than polyvinyl chloride, which has been commonly used as a material for cables and tubes used in medical applications.

The laminate structure 1 can take various forms depending on its application. For example, it is formed into a tubular shape when used as an insulator for cables and tubes, and into a sheet when used as a sheet for high UV resistance thermostatic chamber houses or as a UV shielding sheet (UV shielding curtain) to shield UV leakage from sterilization chambers and the like.

(Configuration of the Second Layer)

The second layer 11 is composed of a resin composition that includes silicone rubber as the base material 111 and includes the silicone resin fine particles 112, the titanium dioxide fine particles 113, and the nanosilica fine particles 114. For example, an addition-reaction type silicone rubber coating agent or a condensation-reaction type silicone rubber coating agent can be used as the silicone rubber as the base material 111 of the second layer 11. In particular, it is preferable to use an addition-reaction type silicone rubber coating agent from the viewpoint of adhesion and abrasion resistance (i.e., wear resistance) with the first layer 10, which has silicone rubber as its base material.

In order to obtain good slidability and a predetermined wipe resistance (i.e., resistance to being wiped off) on the surface of the laminate structure 1 by the second layer 11, the thickness of the second layer 11 is preferably 3 μm or more. The second layer 11 may be laminated on both sides of the first layer 10. Although the upper limit of the thickness of the second layer 11 is not particularly limited, it is preferable to be not more than 100 μm from the viewpoint of productivity, high flexibility, and high bending property.

The silicone resin fine particles 112 are included in the second layer 11 to give the surface of the second layer 11 irregularities. When the surface is provided with irregularities, the contact area of the second layer 11 when it is in contact with a contacting object is smaller and more slidable than when the surface is flat.

Silicone resin has fewer reactive groups (e.g., methyl groups) than silicone rubber and is harder than silicone rubber. Therefore, the silicone resin fine particles 112 can more effectively suppress the deformation of surface irregularities when the second layer 11 is in contact with the contacting object than the silicone rubber particles. This is because when a pressing pressure is applied to the surface of the second layer 11 by the contacting object, the higher hardness of the fine particles can suppress the deformation of the surface irregularities of the second layer 11. This reduces the increase in the contact area of the second layer 11 with the contacting object and maintains the slidability.

The bond energy between atoms in the molecular structure of silicone resin is higher than that of silicone rubber. Therefore, silicone resin is more resistant to UV-C light than silicone rubber.

For example, C—H bonds, which are abundant in silicone rubber, are broken by UV-C irradiation because the bond energy (about 4.27 eV) is less than the energy of UV-C light (about 6.2 eV), Si—O bonds, which are abundant in silicone resins, have a bond energy (about 6.52 eV) greater than the energy of UV-C light, so the bonds are not broken by UV-C light irradiation. Therefore, the silicone resin fine particles 112 are superior to the silicone rubber particles in terms of resistance to UV-C light.

In addition, silicone resin has a lower density than silica. Therefore, the silicone resin fine particles 112 are more difficult to settle in liquid silicone rubber, the base material in the manufacturing process of the second layer 11, than the silica fine particles. In other words, the silicone resin fine particles 112 are superior to the silica fine particles in terms of dispersibility in liquid silicone rubber (in the second layer 11).

The average particle size of the silicone resin fine particles 112 is, e.g., 1 μm or more and 10 μm or less. The concentration (mass %) of the silicone resin fine particles 112 in the second layer 11 is, e.g., 10 mass % or more and 60 mass % or less. Herein, “average particle size” in the present specification refers to that measured by the laser diffraction scattering method, including those of the titanium dioxide fine particles and nanosilica fine particles described below.

The titanium dioxide fine particles 113 in the second layer 11 can shield UV-C light by absorption and/or scattering. Here, UV-C light is ultraviolet light in the wavelength range of 200 nm to 280 nm. By shielding the UV-C light, the titanium dioxide fine particles 113 can suppress the degradation of the base material 111 made of silicone rubber due to UV-C light. The TiO₂ comprising the titanium dioxide fine particles 113 may be anatase, rutile, or brookite type, or a mixture of two or more of these. Niobium oxide may also be added to the titanium dioxide to provide stability. The average particle size of the titanium dioxide fine particles 113 is, e.g., 100 nm to 300 nm.

The Ti concentration in the second layer 11 is preferably 1.0 mass % or more and 4.4 mass % or less. By including TiO₂ fine particles 113 at a Ti concentration of 1.0 mass % or more in the second layer 11, it is possible to suppress the formation of cracks, which may reach of the first layer 10, on the surface of the laminate structure 1, due to bending test equivalent to 45% to 50% tensile after exposure to UV-C light at 1404 J/cm². The method of the bending test and the method of observing the presence or absence of cracks are described below.

On the other hand, when the second layer 11 includes titanium dioxide fine particles 113 with a Ti concentration exceeding 4.4 mass %, the surface roughness of the second layer 11 becomes larger. The larger surface roughness makes it easier for dirt and bacteria to adhere and more difficult to remove. In addition, when the titanium dioxide fine particles 113 with a Ti concentration exceeding 4.4 mass % are included, the adhesion between the base material 111 made of silicone rubber and the silicone resin fine particles 112 decreases, and the silicone resin fine particles 112 easily fall off, and the surface slidability of the second layer 11 decreases. For this reason, the Ti concentration in the second layer 11 is preferably not greater than 4.4 mass %.

All of the Ti in the second layer 11 is included in the titanium dioxide fine particles 113. The Ti concentration in the second layer 11 is determined as the mean value in a measuring area of 125 μm wide×95 μm high using an energy-dispersive X-ray analyzer (EDS) mounted on a scanning electron microscope (SEM).

To suppress the formation of aggregates of the silicone resin fine particles 112 and the titanium dioxide fine particles 113 on the surface of the second layer 11 and to uniformly disperse the titanium dioxide fine particles 113 inside the second layer 11, it is preferable to use titanium dioxide fine particles with hydrophobic surface treatment as the titanium dioxide fine particles 113. In order to suppress the formation of aggregates of the nanosilica fine particles 114 on the surface of the second layer 11 and to uniformly disperse the titanium dioxide fine particles 113 inside the second layer 11, it is preferable to use nanosilica fine particles with hydrophobic surface treatment as the nanosilica fine particles 114. In other words, by using fine particles with hydrophobic surface treatment as the titanium dioxide fine particles 113 and the nanosilica fine particles 114, respectively, the formation of aggregates of the silicone resin fine particles 112 and the titanium dioxide fine particles 113 can be suppressed, and the formation of aggregates of the nanosilica fine particles 114 can be suppressed.

In order to reduce the degradation of the base material 111 by UV-C light, other metal oxide fine particles such as zinc oxide and iron oxide may be used in place of the titanium dioxide fine particles 113.

The nanosilica fine particles 114 impart thixotropy to the liquid resin composition as the coating solution, which is the raw material of the second layer 11. At this stage, the nanosilica fine particles 114 constitute a bulky mesh structure in the liquid, and this structure slows the settling (i.e., reducing the sedimentation rate) of the aggregates of the silicone resin fine particles 112 and the titanium dioxide fine particles 113, thereby inhibiting settling. The average particle size of the nanosilica fine particles 114 is, e.g., 10 nm to 30 nm.

In order to effectively suppress the sedimentation of aggregates of the silicone resin fine particles 112 and the titanium dioxide fine particles 113, the mass % concentration of the nanosilica fine particles 114 in the second layer 11 is preferably at least 1.14 times the mass % concentration of Ti in the second layer 11. In order to keep the viscosity of the liquid resin composition, which is the raw material of the second layer 11, within a suitable range, such as for depositing the second layer 11 to a uniform thickness, the concentration of the nanosilica fine particles 114 in the second layer 11 is preferably 11.5 mass % or less.

(Configuration of the First Layer)

The first layer 10 may include the titanium dioxide fine particles 113 as well as the second layer 11 to reduce the degradation due to UV-C light transmitted through the second layer 11.

As described above, the first layer 10 uses silicone rubber as the base material. When the first layer 10 is used as a sheath material, silicone rubber to which general compounding agents such as various crosslinking agents, crosslinking catalysts, anti-aging agents, plasticizers, lubricants, fillers, flame retardants, stabilizers, and colorants are added may be used as the base material.

(Method of Manufacturing the Laminate Structure)

The laminate structure 1 is produced by curing a liquid resin composition, which is the raw material of the second layer 11, adhered to the surface of the first layer 10. The liquid resin composition, which is the raw material of the second layer 11, includes the silicone resin fine particles 112, the titanium dioxide fine particles 113, the nanosilica fine particles 114, silicone rubber, and an organic solvent. The liquid resin composition may include metal oxide fine particles such as zinc oxide and iron oxide instead of the titanium dioxide fine particles 113. The liquid resin composition may also include multiple types of metal oxide fine particles, such as titanium dioxide and zinc oxide.

In the liquid resin composition, the silicone rubber liquefied by the organic solvent includes the silicone resin fine particles 112, the titanium dioxide fine particles 113, and the nanosilica fine particles 114. By heating the liquid resin composition, the organic solvent evaporates, and the silicone rubber cures, resulting in the second layer 11 comprising a solid resin composition.

As organic solvents in the liquid resin composition, e.g., aromatic hydrocarbon solvents such as toluene and xylene, aliphatic hydrocarbon solvents such as n-hexane, n-heptane, n-octane, isooctane, nonane, decane, undecane, and dodecane can be used alone or in a mixture of two or more solvents. For example, alcohols such as ethanol, isopropyl alcohol, and acetone can be used.

When producing the liquid resin composition, in order to more effectively suppress the progress of separation by the sedimentation of the aggregates of the silicone resin fine particles 112 and the titanium dioxide fine particles 113, it is preferable that the nanosilica fine particles 114 are added to the mixture of silicone rubber, the titanium dioxide fine particles 113, and organic solvent, followed by the addition of the silicone resin fine particles 112.

### Effect of the First Embodiment

According to the first embodiment of the invention, the second layer 11 includes the silicone resin fine particles 112 and the titanium dioxide fine particles 113, so that the laminate structure 1 is provided with slidability and UV-C resistance. In the liquid resin composition that is the raw material of the second layer 11, the nanosilica fine particles 114 suppress the settling of the aggregates of the silicone resin fine particles 112 and the titanium dioxide fine particles 113. Therefore, even when the laminate structure 1 is continuously manufactured for a long time, the segregation in the position and the reduction in the content of the silicone resin fine particles 112 and the titanium dioxide fine particles 113 in the second layer 11 can be suppressed. In other words, by the second layer 11 including the nanosilica fine particles 114, even when the laminate structure 1 is continuously manufactured for a long time (over a long period of time), the slidability and UV-C resistance described above are provided throughout the laminate structure 1.

### Second Embodiment

The second embodiment of the invention relates to a cable or tube with an insulator comprising the laminate structure 1 according to the first embodiment. As an example, a cable used for medical ultrasonic probe cables will be described below.

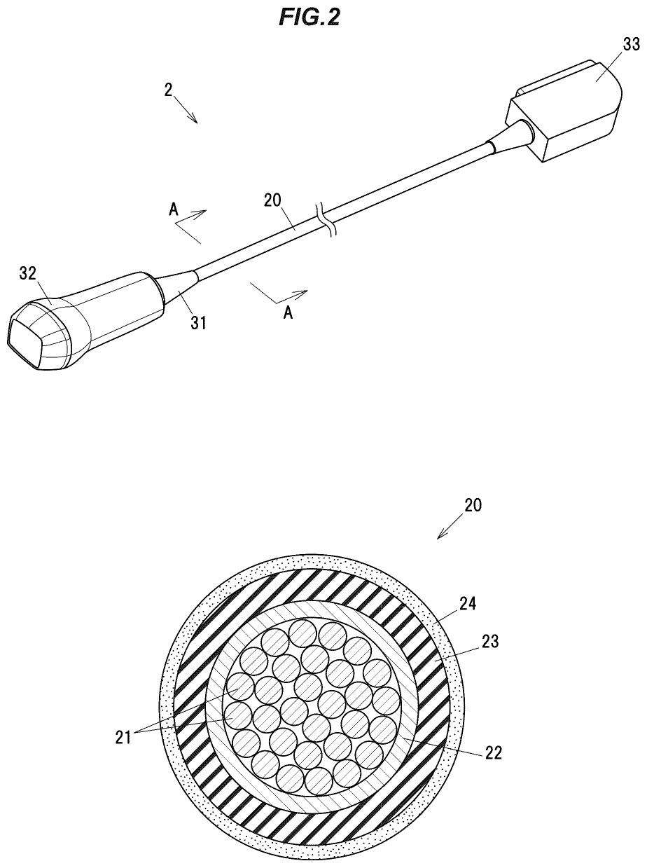

FIG. 2A is a perspective view schematically showing an ultrasonic probe cable 2 according to the second embodiment of the invention. In the ultrasonic probe cable 2, an ultrasonic probe 32 is attached to one end of a cable 20 via a boot 31 protecting the one end, as shown in FIG. 2A. Meanwhile, a connector 33 that connects to a main body of an ultrasonic imaging device is attached to the other end of the cable 20.

FIG. 2B is a radial cross-sectional view of the cable 20 of the ultrasonic probe cable 2 taken along line A-A described in FIG. 2A. The cable 20 includes, e.g., a plurality of wires 21, typically a plurality of coaxial cables, and a shield 22 such as a braided shield is provided to cover the plurality of wires 21. A sheath 23 is then provided to cover the shield 22. Furthermore, in the cable 20, a coating film 24 is formed around the sheath 23 described above and adheres closely to the sheath 23.

The sheath 23 and the coating film 24 of the cable 20 comprise the first layer 10 and the second layer 11 of the laminate structure 1, respectively. In other words, the laminate structure 1 is used as the sheath 23 and the coating film 24 in the cable 20. The silicone resin fine particles 112, the titanium dioxide fine particles 113, and the nanosilica fine particles 114 in the coating film 24 are omitted from the drawings.

Since the laminate structure 1, which has slidability and UV-C resistance entirely, is used as the insulator (the sheath 23 and the coating film 24) of the cable 20, the cable 20 has slidability and UV-C resistance throughout the entire cable. Therefore, snagging caused by the sticky surface of the sheath 23 can be suppressed, and sterilization by UV-C light irradiation can be performed. The thickness of the coating film 24 is, e.g., 3 μm or more and 100 μm or less.

(Method of Manufacturing the Cable)

An example of a manufacturing method for the cable 20 according to the present embodiment will be described. First, a plurality of wires (i.e., electric wires) 21 (e.g., 100 or more wires) are bundled together in a batch. Then, a shield 22 is formed to cover the bundled plurality of wires 21.

Next, the first layer 10 and the second layer 11 of the laminate structure 1 are formed in sequence to cover the shield 22 to form the sheath 23 and the coating film 24. The sheath 23 is formed, e.g., by extrusion molding using an extruder. The coating film 24 is formed, e.g., by using a coating device 4 shown below.

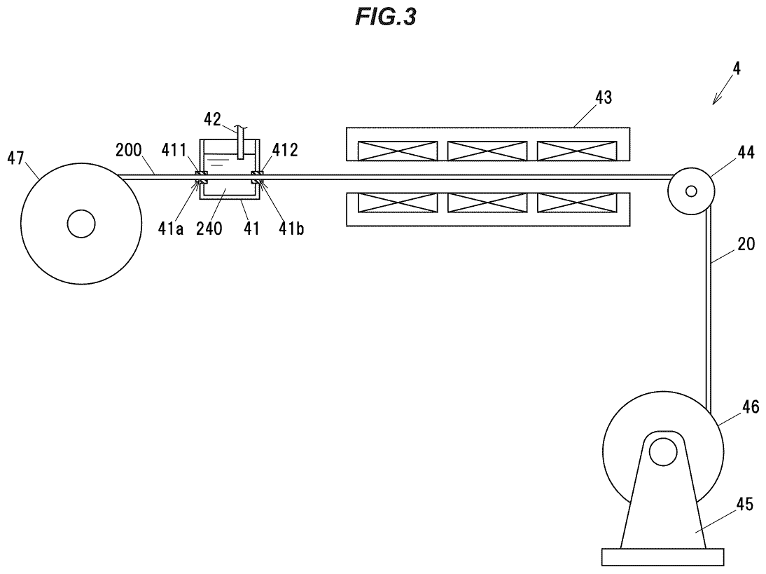

FIG. 3 is a schematic diagram showing a configuration example of the coating device 4 used for coating the cable 20 with a coating film 24. The coating device 4 is equipped with a tank 41, a refill introduction tube 42, an electric furnace 43, a pulley 44, and a winder 45. The tank 41 is continuously fed with a cable 200, which is the cable 20 before being coated with the coating film 24, from a supply drum 47. The cable 200 includes the plurality of wires 21, the shield 22, and the sheath 23. In the winder 45, a winding drum (i.e., take-up drum) 46 is set to wind the cable 20 coated with the coating film 24.

The process of forming the coating film 24 includes a step of adhering a liquid resin composition 240 as a coating liquid to the surface of the cable 200 and a step of heating the cable 200 with the liquid resin composition 240 adhered to the cable 200 to cure the liquid resin composition 240. The liquid resin composition 240 becomes the coating film 24 by curing. Here, the liquid resin composition 240 is the same as the liquid resin composition that is the raw material of the second layer 11 described in the first embodiment.

In the step of adhering the liquid resin composition 240 to the surface of the cable 200, the cable 200 fed from the supply drum 47 is moved in its longitudinal direction and passed through the liquid resin composition 240 stored in the tank 41 to adhere the liquid resin composition 240 to the surface of the sheath 23.

The tank 41 includes an inlet section 41a and an outlet section 41b. The cable 200 entering the tank 41 from the inlet section 41a passes through the tank 41 in a horizontal direction toward the outlet section 41b in such a manner that its longitudinal direction is horizontal. A cover 411 such as packing or felt material is attached to the inlet section 41a to cover the cable 200 to prevent leakage. A felt material 412 having a hole through which the cable 200 can pass is attached to the outlet section 41b to allow the liquid resin composition 240 to adhere to the surface of the cable 200. The liquid resin composition 240 that permeates the porous felt material 412 can adhere to the surface of the cable 200. The tank 41 is refilled with the liquid resin composition 240 from time to time from the refill introduction tube 42.

In the step of curing the liquid resin composition 240, the silicone rubber of the liquid resin composition 240 is crosslinked by heating the cable 200 with the liquid resin composition 240 by means of the electric furnace 43 while moving the cable 200 with the liquid resin composition 240 in its longitudinal direction. To promote this crosslinking, a catalyst such as platinum may be used. The liquid resin composition 240 dries and cures as it is heated by the electric furnace 43. In the example shown in FIG. 3, the electric furnace 43 is positioned laterally to the tank 41, and the pulley 44 is positioned further forward in the line feed direction of the electric furnace 43. The cable 200 with the liquid resin composition 240 attached moves in the electric furnace 43 in such a manner that its longitudinal direction is horizontal.

The temperature and horizontal length of the electric furnace 43 are set so that the curing progresses to the extent that plastic distortion or peeling does not occur in the coating film 24 when the cable 20, with the coating film 24 after the liquid resin composition 240 has cured, is guided by the pulley 44 and wound onto the winding drum 46.

After passing through the electric furnace 43, the cable 20 is guided by the pulley 44 to change its direction of travel and is wound onto the winding drum 46, which is located lower than the pulley 44. The cable 20 is then cut to a predetermined length, terminal processing is performed, and an ultrasonic probe 32, a connector 33, and a boot 31 are attached to obtain the ultrasonic probe cable 2.

As another example of a cable or tube with an insulator made of the laminate structure 1, the configuration of a tube (hollow tube) used for medical applications such as catheters will be described below.

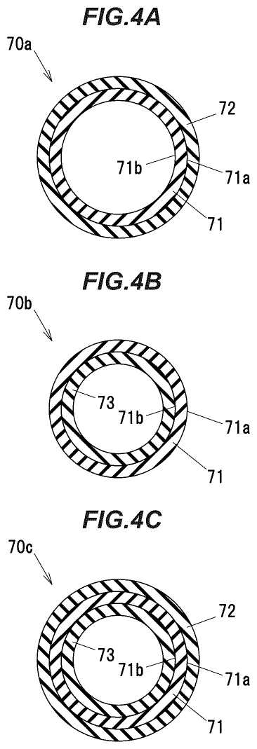

FIGS. 4A to 4C are radial cross-sectional views of medical tubes 70a, 70b, and 70c, respectively, according to the second embodiment of the invention. The medical tube 70a shown in FIG. 4A includes an outer coating film 72 on an outer surface 71a of a tube main body 71. The medical tube 70b shown in FIG. 4B includes an inner coating film 73 on an inner surface 71b of the tube main body 71. The medical tube 70c shown in FIG. 4C includes an outer coating film 72 and an inner coating film 73 on an outer surface 71a and an inner surface 71b of the tube main body 71, respectively.

As illustrated in the medical tubes 70a, 70b, and 70c, the tube in the present embodiment includes the tube main body 71, the outer coating film 72 covering the outer surface 71a of the tube main body 71, the inner coating film 73 covering the inner surface 71b of the tube main body 71, or both the outer coating film 72 and the inner coating film 73.

The tube main body 71 of the medical tubes 70a, 70b, 70c comprises the first layer 10 of the laminate structure 1, while the outer coating film 72 and the inner coating film 73 comprise the second layer 11 of the laminate structure 1. Therefore, the medical tubes 70a, 70b, and 70c have slidability and UV-C resistance throughout, similar to the cable 20 of the ultrasonic probe cable 2 described above. Therefore, when the tubes are used as tubes for inserting instruments inside, e.g., medical tubes such as catheters, smooth insertion and removal of instruments is possible, and sterilization by UV-C light irradiation can be performed.

In addition, the tube according to the present embodiment can be used for endoscopic surgical tube sets, ultrasonic surgical tube sets, hematology analyzer tubes, oxygen concentrator internal piping, dialysis blood circuits, artificial heart-lung circuits, and endotracheal tubes.

### Effect of the Second Embodiment

According to the second embodiment of the invention, by using the laminate structure 1 as an insulator, it is possible to provide cables such as the cable 20 used for the ultrasonic probe cable 2 and the medical tubes 70a, 70b, 70c, etc., which are provided with slidability and UV-C resistance throughout, even when manufactured continuously for a long time.

### Example 1

The effect of the nanosilica fine particles 114 on the suppression of sedimentation of aggregates of the silicone resin fine particles 112 and the titanium dioxide fine particles 113 in the liquid resin composition, which is the raw material of the second layer 11, was evaluated. The following Table 1 shows the compositions and preparation process of five types of liquid resin compositions used in this evaluation (designated as samples A1 to A5).

TABLE 1

| | Silicone | Organic | | Silicone | |
|---|---|---|---|---|---|
| | rubber + | solvent | Nanosilica | resin | Preparation |
| Sample | TiO₂ (g) | (g) | (g) | (g) | process |
| A1 | 5.65 | 30 | 0 | 7 | Step 1 |
| A2 | 5.65 | 30 | 0.056 | 7 | Step 1 |
| A3 | 5.65 | 30 | 0.17 | 7 | Step 1 |
| A4 | 5.65 | 30 | 0.28 | 7 | Step 1 |
| A5 | 5.65 | 30 | 0.28 | 7 | Step 2 |

In Table 1, “Silicone rubber+TiO₂” indicates the mass of the mixture of silicone rubber and titanium dioxide fine particles 113, “Organic solvent” indicates the mass of toluene as an organic solvent, “Nanosilica” indicates the mass of nanosilica fine particles 114, and “Silicone resin” indicates the mass of silicone resin fine particles 112. “Step 1” in “Preparation process” is the addition of nano silica fine particles 114 to the mixture of silicone rubber, titanium dioxide fine particles 113, and organic solvent, followed by the addition of the silicone resin fine particles 112, while “Step 2” is the addition of silicone resin fine particles 112 to the mixture of silicone rubber, the titanium dioxide fine particles 113, and organic solvent, followed by the addition of the nanosilica fine particles 114.

The Ti concentration of the second layer 11 formed using samples A1 to A5 was analyzed using an energy dispersive X-ray spectrometer (EDS), and the average value in a measuring area of 125 μm wide×95 μm high was obtained, which was 1.9 mass % in all cases.

The nanosilica fine particles 114 used in samples A1 to A5 are all nanosilica fine particles with an average particle size of 0.020 μm, manufactured by NIPPON AEROSIL CO., LTD. The silicone resin fine particles 112 used in samples A1 to A5 are all silicone resin fine particles with an average particle size of 2 μm, manufactured by Shin-Etsu Chemical Co.

First, samples A1 and A4 were each stirred 200 times with manual shaking and then placed in a 50 ml screw-tube bottle. The bottles were placed at room temperature (23±2° C.) and their appearance was photographed with still images at regular intervals.

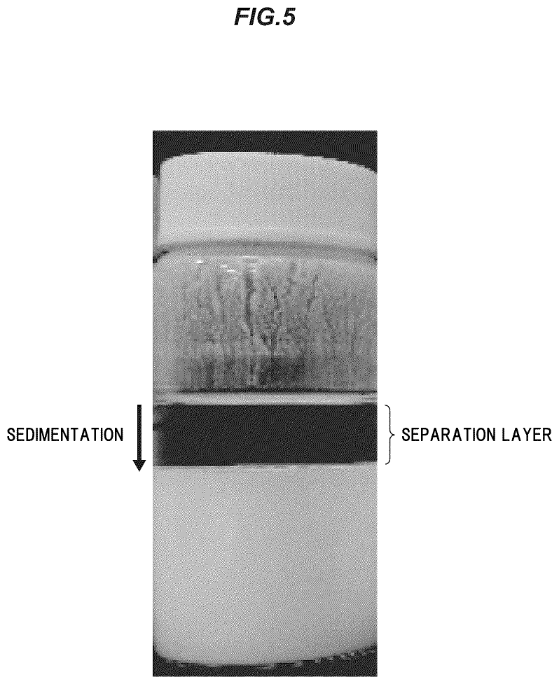

FIG. 5 is a photographic image of a screw-tube bottle including sample A1 that was allowed to stand for 120 minutes. FIG. 5 shows a transparent separation layer that appears as the aggregates of the silicone resin fine particles 112 and the titanium dioxide fine particles 113 in sample A1 settle. The width of this separation layer increases as the agglomerates of the silicone resin fine particles 112 and the titanium dioxide fine particles 113 settle, so the degree of sedimentation can be measured by measuring the width of the separation layer.

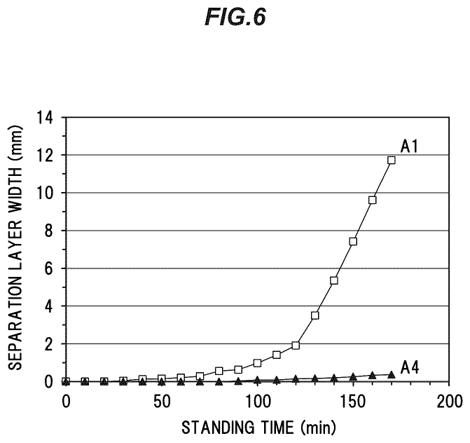

FIG. 6 is a graph showing the change in the width of the separation layer of samples A1 and A4 as a function of the time elapsed since they were placed in a static state. The width of the separation layer of sample A1 and sample A4 was measured from the photographic images taken above using image-processing software “ImageJ”.

According to FIG. 6, the separation layer did not appear in sample A1 until 50 minutes had elapsed, but a 2 mm wide separation layer appeared at 120 minutes, and the width of the separation layer became 12 mm after 160 minutes. In contrast, in sample A4, no separation layer appeared until 130 minutes had elapsed, and a separation layer of less than 0.5 mm appeared after 130 to 160 minutes. The width of the separation layer of sample A2 and sample A3 was also measured in the same manner, but no difference was observed between them and sample A4.

These results may be due to the fact that in samples A2 to A4 including the nanosilica fine particles 114, the sedimentation of the aggregates of the silicone resin fine particles 112 and the titanium dioxide fine particles 113 was suppressed by the nanosilica fine particles 114.

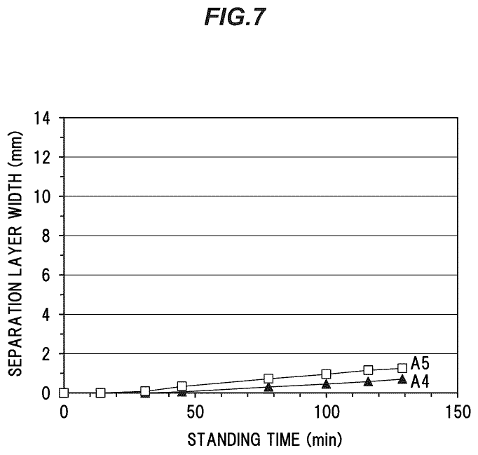

FIG. 7 is a graph showing the change in the width of the separation layer of samples A4 and A5 as a function of the time elapsed since they were placed in a static state. Sample A4 and sample A5 have the same compositions and differ in the order in which the silicone resin fine particles 112 and the nanosilica fine particles 114 are added, as shown in Table 1. The width of the separation layer of sample A5 was measured by the same method as for samples A1 to A4. The measured values of sample A4 in FIG. 7 do not match the measured values of sample A4 in FIG. 6, but this is due to the fact that these measured values were obtained from measurements performed separately. The measurements of sample A1 and sample A4 for FIG. 6 were performed on the same day, and the measurements of sample A4 and sample A5 for FIG. 7 were performed on the same day.

FIG. 7 shows that the rate of increase in the width of the separation layer over time was smaller for sample A4 than for sample A5, and that a difference in the width of the separation layer for both samples began to appear after 30 to 40 minutes had passed. This is thought to be due to the fact that adding the nanosilica fine particles 114 before the silicone resin fine particles 112 provides the aggregation of the titanium dioxide fine particles 113 and the nanosilica fine particles 114, and inhibits the formation of aggregates of the titanium dioxide fine particles 113 and the silicone resin fine particles 112 that settle down.

Next, viscosity measurements of samples A1 to A4 were performed to investigate the relationship between the degree of sedimentation of aggregates of the titanium dioxide fine particles 113 and the silicone resin fine particles 112 and the concentration of nanosilica fine particles 114.

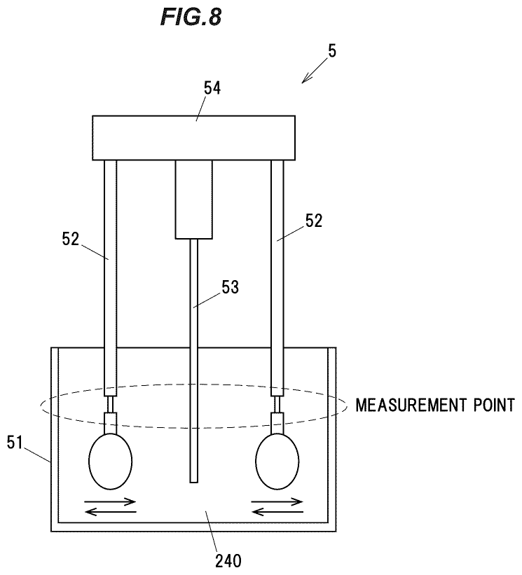

FIG. 8 is a schematic diagram of the tuning-fork vibro viscometer (tuning-fork vibro viscometer SV-10H manufactured by A&D Corporation) 5 used to measure the viscosity of samples A1 to A4. The tuning-fork vibro viscometer 5 consists of a container 51 (sample container AX-SV-34) in which a liquid resin composition 240 such as samples A1 to A4 is stored, a transducer (i.e., oscillator) 52 whose tip vibrates in the liquid resin composition 240 at a constant width, a temperature sensor 53 that measures the temperature of the liquid resin composition 240, and an electromagnetic drive unit 54 that vibrates the transducer 52. The tuning-fork vibro viscometer 5 resonates the transducer 52 in the liquid resin composition 240 and determines the viscosity from the excitation force required to amplify the transducer 52 by a constant width.

The mechanism by which the degree of sedimentation of the aggregates of the titanium dioxide fine particles 113 and the silicone resin fine particles 112 can be measured by viscosity measurement is as follows. As sedimentation progresses, the solid components of the liquid resin composition 240 gather in the lower layer, and the viscosity of the lower layer is considered to increase. In this state, if the change in viscosity can be measured without giving any force to the liquid resin composition 240 to be stirred, it can be said that the change in viscosity represents the degree of sedimentation. Since the tuning-fork vibro viscometer 5 can measure viscosity by means of weak vibration, it can measure viscosity in real time without applying force to the liquid resin composition 240. Therefore, the tuning-fork vibro viscometer 5 can measure the viscosity of the liquid resin composition 240 in a static state and quantitatively evaluate the state of sedimentation of the liquid resin composition 240.

The viscosity measurements were performed with the entire measurement system placed at room temperature (23±2° C.). The viscosity measured in real time with a tuning-fork vibro viscometer 5 was recorded along with temperature changes using data communication software “RsVisco” manufactured by A&D Corporation.

Samples A1 to A4 were shaken 200 times with manual shaking just before the start of measurement, 10 ml was divided into the container 51, and the measurement was performed by keeping the transducer 52 of the tuning-fork vibro viscometer 5 in the liquid while it remained in static state. The measurement results are output as a plot of temperature and viscosity with respect to measurement time.

The value of the sample temperature was checked to confirm that it did not change during the measurement time in a way that could affect the viscosity. If the temperature value for the measurement time alone could not be confirmed, a graph was created with the temperature on the horizontal axis and the viscosity on the vertical axis, and it was confirmed that there was no correlation between the viscosity and the temperature. If the temperature change was large and it was determined that the temperature change affected the viscosity, the viscosity was measured again with a constant temperature system.

The viscosity at the measurement time of 0 minutes was defined as the initial viscosity μ₀, and the viscosity at the measurement time T was defined as μ_{T}. Viscosity change rate (i.e., rate of change in viscosity) X from the initial state was defined as “X=((μ_{T}−μ₀)/μ₀)×100,” and the sample viscosity was considered constant when the variation of this change rate X was within ±2% within a certain time. The index of “within ±2%” was set after considering that the repeatability (standard deviation of measured values) of the tuning-fork vibro viscometer 5 is 1% and the influence of external factors that affect the measurement of the tuning-fork vibro viscometer 5.

When the sample temperature is within the range that does not affect the viscosity and the variation of the viscosity change rate X is within ±2% within a certain time, the dispersion state of particles in the sample is constant. In contrast, when the sample temperature is within the range that does not affect the viscosity and the variation of the viscosity change rate X is not within ±2%, the dispersion state of particles in the sample is not constant. In particular, when the viscosity change rate X is increasing, it can be judged that the particles in the composition are settling in resin compositions that do not cure over time, such as samples A1 to A4.

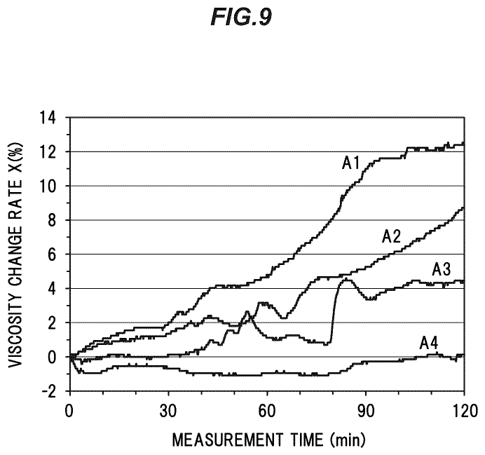

FIG. 9 is a graph showing the viscosity change rate X with respect to measurement time for samples A1 to A4. According to FIG. 9, sample A1, which does not include nanosilica fine particles 114 and showed sedimentation in the measurement of the separation layer width as shown in FIG. 6, shows a large increase in the viscosity change rate X over time, and the viscosity change rate X after 120 minutes is approximately 12%. This suggests that in sample A1, the position of the particles in the sample, mainly the aggregates of the titanium dioxide fine particles 113 and the silicone resin fine particles 112, was not stable and sedimentation occurred.

In contrast, samples A2, A3, and A4 showed a smaller increase in the viscosity change rate X over time than sample A1, with viscosity change rates X of 8.6%, 4.5%, and 0%, respectively, after 120 minutes. This indicates that particle sedimentation was suppressed in samples A2, A3, and A4 compared to sample A1.

However, the viscosity change rate X of samples A2 and A3 increases with time, albeit more slowly than that of sample A1, and is greater than 2% at 120 minutes. This indicates that the viscosities of samples A2 and A3 are not constant, and a certain degree of particle sedimentation occurs. On the other hand, the viscosity change rate X of sample A4 increased very little over time and was within ±2% at 120 minutes elapsed. This indicates that the viscosity of sample A4 is almost constant and that little particle sedimentation occurs.

When the second layer 11 is formed using samples A1 to A4, all organic solvents are removed from the components shown in Table 1. Therefore, the concentration of the nanosilica fine particles 114 in the second layer 11 formed using samples A1, A2, A3, and A4 is 0 mass %, 0.441 mass %, 1.33 mass %, and 2.17 mass %, respectively. The concentration of the nanosilica fine particles 114 is determined by [(mass of nanosilica)/{(mass of silicone rubber)+(mass of TiO₂)+(mass of nanosilica)+(mass of silicone resin)]*100.

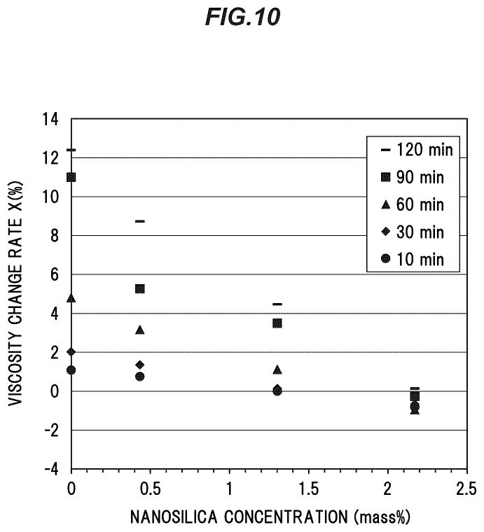

FIG. 10 is a graph showing the relationship between the viscosity change rate X of samples A1 to A4 and the concentration of the nanosilica fine particles 114 in the second layer 11 formed using samples A1 to A4. The “10 minutes”, “30 minutes”, “60 minutes”, “90 minutes”, and “120 minutes” in FIG. 10 are the measurement times in the graph in FIG. 9, respectively.

According to FIG. 10, the viscosity change rate X tends to become smaller as the concentration of the nanosilica fine particles 114 in the second layer 11 increases. Specifically, when the concentration of the nanosilica fine particles 114 in the second layer 11 is 2.17 mass % or more, the viscosity change rate X is within ±2% when the measurement time is 0 to 120 minutes. This indicates that the sedimentation of aggregates of the silicone resin fine particles 112 and the titanium dioxide fine particles 113 is effectively controlled.

Here, the concentration of the nanosilica fine particles 114 required to effectively suppress the sedimentation of the aggregates of the silicone resin fine particles 112 and the titanium dioxide fine particles 113 is proportional to the concentration of the titanium dioxide fine particles 113. And since the Ti in the second layer 11 is included in the titanium dioxide fine particles 113, the concentration of the nanosilica fine particles 114 required to effectively suppress the sedimentation of the aggregates of the silicone resin fine particles 112 and the titanium dioxide fine particles 113 is proportional to the Ti concentration in the second layer 11.

As mentioned above, the Ti concentration of the second layer 11 formed using samples A1 to A4 is 1.9 mass %, and according to FIG. 10, the sedimentation of the aggregates of the silicone resin fine particles 112 and the titanium dioxide fine particles 113 is effectively suppressed when the concentration of the nanosilica fine particles 114 in the second layer 11 is 2.17 mass % or more. Therefore, it can be said that the sedimentation of the aggregates of the silicone resin fine particles 112 and the titanium dioxide fine particles 113 is effectively suppressed when the mass % concentration of nanosilica fine particles 114 in the second layer 11 is 2.17/1.9 times or more, i.e., 1.14 times or more than the mass % concentration of Ti. The Ti concentration is determined as the average value in a measuring area of 125 μm wide×95 μm high when the second layer 11 is evaluated using an energy-dispersive X-ray analyzer (EDS) mounted on a scanning electron microscope (SEM).

On the other hand, in the liquid resin composition that is the raw material of the second layer 11, the greater the viscosity, the more difficult it becomes to deposit the second layer 11 to a uniform thickness, and when coating is performed by the dip coating method, the greater the viscosity, the greater the thickness of the second layer 11. As mentioned above, the thickness of the second layer 11 is preferably 100 μm or less from the viewpoint of high flexibility and high bending property. In this case, the viscosity of the liquid resin composition, which is the raw material of the second layer 11, is preferably 30 mPa·s or less.

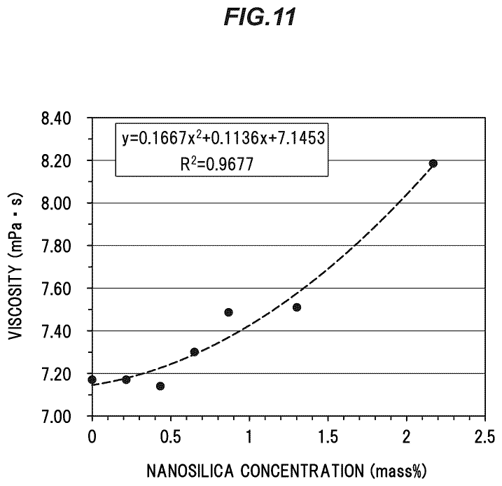

FIG. 11 is a graph showing the relationship between the viscosity of the liquid resin composition and the concentration of nanosilica fine particles 114 in the second layer 11, obtained by viscosity measurement of seven samples including samples A1 to A4 with different concentrations of the nanosilica fine particles 114. The seven samples for this viscosity measurement all include the same concentration of the titanium dioxide fine particles 113, and the Ti concentration of the second layer 11 formed using these seven samples was all 1.9 mass %. The common conditions for the seven samples are 5.65 g of “silicone rubber+TiO₂”, 30 g of “organic solvent”, and 7 g of “silicone resin”. Then, the amount of nanosilica added was changed so that the nanosilica concentration was 0 mass % (sample A1), 0.217 mass %, 0.441 mass % (sample A2), 0.651 mass %, 0.868 mass %, 1.33 mass % (sample A3), and 2.17 mass % (sample A4). The viscosities (mPa s) of the coating liquids at nanosilica concentrations of 0 mass %, 0.217 mass %, 0.441 mass %, 0.651 mass %, 0.868 mass %, 1.33 mass %, and 2.17 mass % were 7.17, 7.17, 7.14, 7.30, 7.49, 7.51, and 8.18, respectively.

According to the approximate curve y=0.1667x²+0.1136x+7.1453 shown in FIG. 11, the viscosity of the liquid resin composition becomes less than 30 mPa·s when the concentration of the nanosilica fine particles 114 in the second layer 11 is approximately 11.5 mass % or less. Therefore, in order to keep the viscosity of the liquid resin composition within a suitable range, the concentration of the nanosilica fine particles 114 in the second layer 11 is preferably 11.5 mass % or less.

There is no difference in the effect of suppressing sedimentation of aggregates of the silicone resin fine particles 112 and the titanium dioxide fine particles 113, regardless of whether hydrophilic surface-treated nanosilica fine particles or hydrophobic surface-treated nanosilica fine particles are used as nanosilica fine particles 114. However, when hydrophilic surface-treated nanosilica fine particles are used as nanosilica fine particles 114, the aggregates of nanosilica fine particles 114 may be formed on the surface of the second layer 11.

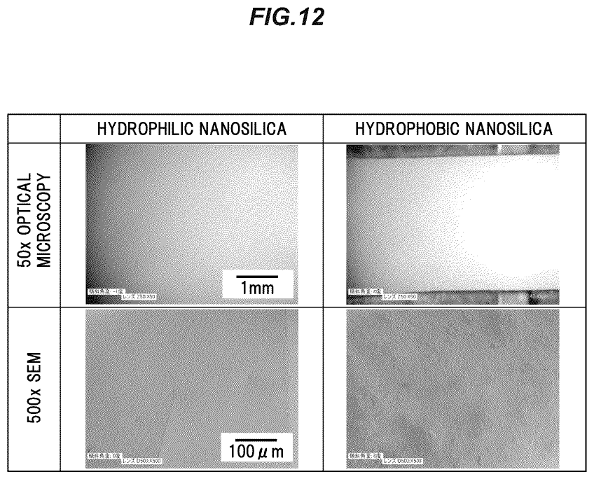

FIG. 12 shows observation images of optical microscope and scanning electron microscope (SEM) of the surface of the second layer 11 when hydrophilic surface-treated nanosilica fine particles (labeled hydrophilic nanosilica) and hydrophobic surface-treated nanosilica fine particles (labeled hydrophobic nanosilica) are used as nanosilica fine particles 114. In both cases, hydrophobic surface-treated titanium dioxide fine particles are used as the titanium dioxide fine particles 113. According to FIG. 12, fine irregularities can be seen on the surface of the second layer 11 in the case where hydrophilic surface-treated nanosilica fine particles are used as nanosilica fine particles 114, which are believed to be due to the presence of aggregates of the nanosilica fine particles 114.

Therefore, in order to suppress the formation of aggregates of the nanosilica fine particles 114 on the surface of the second layer 11 and to uniformly disperse the titanium dioxide fine particles 113 inside the second layer 11, it is preferable to use the nanosilica fine particles 114 with hydrophobic surface treatment as nanosilica fine particles.

### Example 2

The addition of the nanosilica fine particles 114 to the second layer 11 did not change the UV-C resistance of the laminate structure 1, as confirmed by testing.

First, we prepared two types of cables 20 (samples B1 and B2), in which a coating film 24 was formed by dip coating with a liquid resin composition, and in which the components of the coating film 24 were different. Table 2 shows the components of samples B1 and B2. As shown in Table 2, sample B1 includes 2.17 mass % of the nanosilica fine particles 114 in the coating film 24, while sample B2 does not include nanosilica fine particles 114 in the coating film 24.

TABLE 2

| | | Coating film 24 | | | |
|---|---|---|---|---|---|
| | | | Silicone | | |
| | | Base | resin fine | Titanium oxide | Nanosilica |
| | Sheath | material | particles | fine particles | fine particles |
| Sample | 23 | 111 | 112 | 113 | 114 |
| B1 | Silicone | Silicone | Silicone | Anatase | Hydrophobic |
| | rubber | rubber | resin fine | titanium | nanosilica |
| | | | particles | dioxide fine | fine |
| | | | | particles | particles |
| | | | | Ti mass %: | (mass %: |
| | | | | 1.9) | 2.17) |
| B2 | Silicone | Silicone | Silicone | Anatase | None |
| | rubber | rubber | resin fine | titanium | |
| | | | particles | dioxide fine | |
| | | | | particles | |
| | | | | (Ti mass %: | |
| | | | | 1.9) | |

Next, the sheath 23 and the coating film 24 were cut from samples B1 and B2, respectively, and the laminate structure of the sheath 23 and the coating film 24 cut from sample B1 was designated as sample C1, and the laminate structure of the sheath 23 and the coating film 24 cut from sample B2 was designated as sample C2. As described above, the sheath 23 and the coating film 24 correspond to the first layer 10 and the second layer 11, respectively, so that samples C1 and C2 comprise the laminate structure 1.

Next, samples C1 and C2 were irradiated with UV-C light using a storage chamber with a sterilizing lamp (DM-5 and GL-10 lamp manufactured by Daishin Kogyo Co., Ltd.) under the following conditions: temperature in the chamber of 25° C. to 40° C., humidity in the chamber of 28% to 65%, pressure in the chamber of 1 atm (atmospheric pressure), wavelength of 253.7 nm, irradiance of 1.3 mW/cm², and irradiation time of 200 hours, 300 hours, 450 hours, and 600 hours. The illuminance meter was a UVC-254A manufactured by MK Scientific.

(Tensile Test)

To verify the UV-C resistance of the laminate structure 1 from its strength against tension, tensile tests were conducted after UV-C light irradiation.

Sheet-like samples C1 and C2 were punched out with a No. 6 dumbbell to provide dumbbell-shaped pieces, and then UV-C light was irradiated on samples C1 and C2. Tensile tests were conducted as specified in “JIS K6251 (1994) under the following conditions: ambience temperature of 15° C. to 35° C., ambience humidity of 28RH % to 65RH %, and atmospheric pressure.

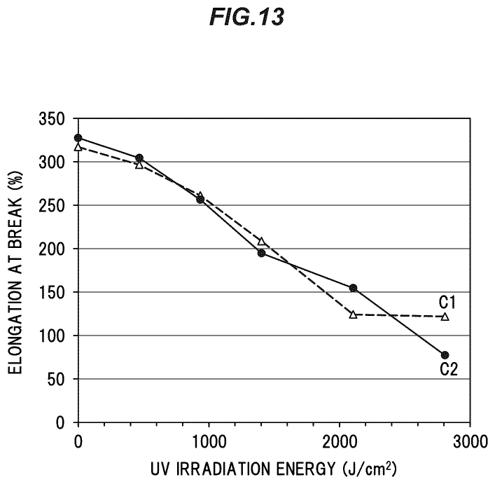

FIG. 13 is a graph showing the results of tensile tests of samples C1 and C2. The horizontal axis indicates the total irradiation energy (irradiance×irradiation time: J/cm²) of UV-C light, and the vertical axis indicates the elongation at break. According to FIG. 13, the elongation at break for both samples C1 and C2 changes as the total irradiation energy irradiation of UV-C light increases, indicating that regardless of whether the second layer 11 includes the nanosilica fine particles 114 or not, the elongation at break changes in the same manner due to UV-C light irradiation.

Specifically, the elongation at break as measured by tensile tests after irradiation of UV-C light of 1404 J/cm² was 210% for sample C1 including the nanosilica fine particles 114 in the second layer 11, and 195% for sample C2 without nanosilica fine particles 114 in the second layer 11. It was found that when irradiated with UV-C light of 1404 J/cm², the value of the elongation at break of the laminate structure 1 including the nanosilica fine particles 114 in the second layer 11 is no more than 30% lower than the value of the elongation at break when the second layer 11 does not include nanosilica fine particles 114.

The elongation at break as measured by tensile tests after irradiation of UV-C light of 2808 J/cm² was 122% for sample C1 including the nanosilica fine particles 114 in the second layer 11, and 77% for sample C2 without nanosilica fine particles 114 in the second layer 11. It was found that when irradiated with UV-C light of 2808 J/cm², the value of the elongation at break of the laminate structure 1 including nanosilica fine particles 114 in the second layer 11 is not more than 30% lower than the value of the elongation at break when the second layer 11 does not include nanosilica fine particles 114.

(Bending Test)

To verify the UV-C resistance of the laminate structure 1 in terms of strength against bending, bending tests after UV-C light irradiation were conducted.

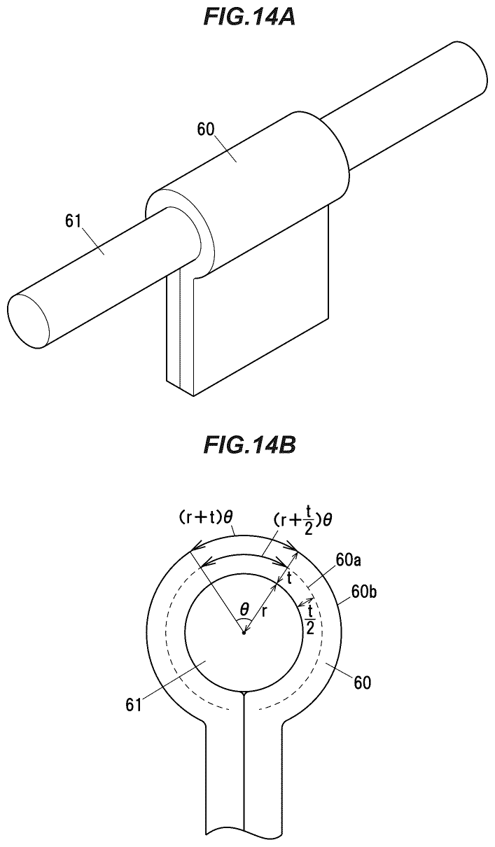

FIG. 14A is a schematic diagram of the bending test. A test piece 60 in FIG. 14A is a rectangular test piece cut from each of the samples C1 and C2. In the bending test, as shown in FIG. 14A, the test piece 60 is wrapped around a conductor (metal wire) 61 with a radius of 0.5 mm, and the overlapping portions of the test piece 60 are clamped and fixed from both sides (the fixture is not shown). Here, the test piece 60 was cut from samples C1 and C2 in a size that is 12 mm (circumferential direction of cable-shaped samples B1 and B2)×18 mm (length direction of the cable-shaped samples B1 and B2). Here, the test piece 60 was then wrapped around the conductor 61 in such a manner that the 18 mm long edge was along the circumferential direction of the conductor 61 and the second layer 11 was on the outside.

FIG. 14B is a cross-sectional view of the conductor 61 and the test piece 60 wrapped around the conductor 61 in the radial direction of the conductor 61. If the radius of the conductor 61 is r and the thickness of the test piece 60 is t, as shown in FIG. 14B, the length of the test piece 60 in the longitudinal direction at a neutral plane 60a of the test piece 60 at an arbitrary angle θ is (r+t/2)·θ and the length of the test piece 60 in the longitudinal direction at an outer circumference surface 60b of the test piece 60 at is (r+t)·θ. Therefore, the elongation rate in the longitudinal direction of the outer circumferential surface 60b of the test piece 60 wrapped around the conductor 61 is expressed as {(r+t)·θ−(r+t/2)·θ}/((r+t/2)·θ)×100=t/(2r+t)×100, where the radius r of the conductor 61 is 0.5 mm and the thickness t of the test piece 60 is 0.82 mm, which is approximately 45%.

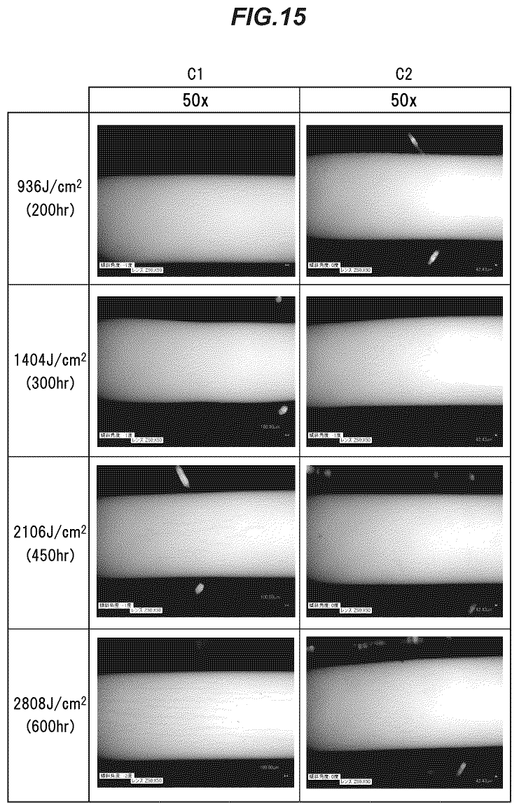

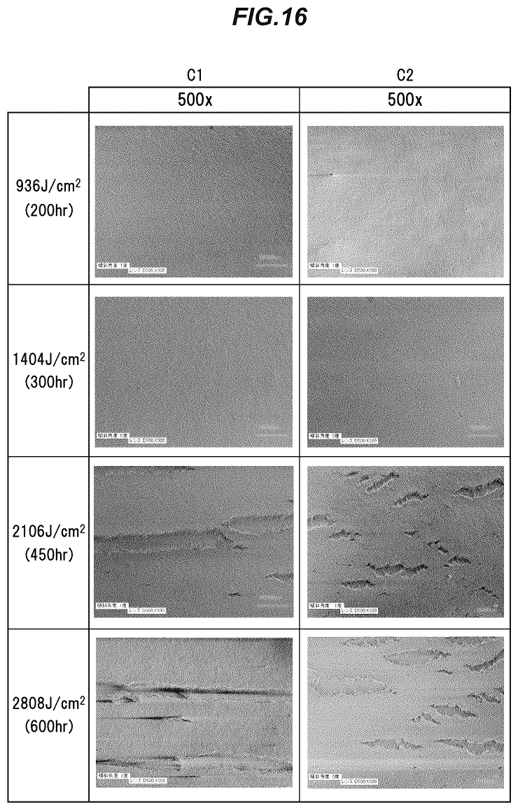

Bending tests were performed on the test pieces 60 cut from samples C1 and C2. The surface of test piece 60 at the time of the bending test (when the second layer 11 was subjected to an elongation equivalent to 45% to 50%) was observed using an optical microscope (Keyence Corporation, Digital Microscope VHX-1000) and a scanning electron microscope (Keyence Corporation, VHX-D 510) were observed. These observed images are shown in FIGS. 15 and 16.

FIG. 15 shows observed images of the surface of test pieces 60 cut from samples C1 and C2, observed with an optical microscope at a magnification of 50×. FIG. 16 shows observed images of the surface of test pieces 60 cut from samples C1 and C2, observed by scanning electron microscope at a magnification of 500×.

As shown in FIGS. 15 and 16, it was confirmed that no cracks appeared on the surface of the test piece 60 cut from sample C2, which does not include nanosilica fine particles 114 in the second layer 11, when the total irradiation energy of UV-C light was 936 J/cm², 1404 J/cm², 2106 J/cm², and 2808 J/cm². The cracks referred to in this bending test are the concave areas that reach from the second layer 11 (the coating film 24) to the first layer 10 (the sheath 23).

No cracks appeared on the surface of the test piece 60 cut from sample C1, which includes the nanosilica fine particles 114 in the second layer 11, when the total irradiation energy of UV-C light was 936 J/cm². When the total irradiation energy of UV-C light was 1404 J/cm², 2106 J/cm², and 2808 J/cm², slight cracks were observed, but when ten areas of 1.5 mm×4.5 mm were observed using an optical microscope at 50× magnification, cracks were observed in three or less of ten areas of 1.5 mm×4.5 mm. From these results, it was judged that the test piece 60 cut from sample C1 including the nanosilica fine particles 114 in the second layer 11 was also UV-C resistant.

In the above evaluation of this example, no significant difference in UV-C resistance was confirmed between cases where the laminate structure 1 includes the nanosilica fine particles 114 in the second layer 11 and cases where the laminate structure 1 does not include nanosilica fine particles 114 in the second layer 11. However, in the case where the coating film 24 is continuously formed on a long cable as shown in the manufacturing method for cable 20 above, it is important to suppress the sedimentation of aggregates of the silicone resin fine particles 112 and the titanium dioxide fine particles 113 in the liquid resin composition that is the raw material of the coating film 24 to maintain the composition of the second layer 11. Therefore, the laminate structure 1 including the nanosilica fine particles 114 in the second layer 11 is superior in terms of slidability and UV-C resistance throughout.

### Summary of Embodiments

Next, the technical concepts that can be grasped from the above described embodiments will be described with the help of the signs, etc. in the embodiments. However, each sign, etc. in the following description is not limited to the members, etc. specifically shown in the embodiments for the constituent elements in the scope of claims.

According to the first feature, a resin composition includes silicone rubber as a base material, silicone resin fine particles 112, metal oxide fine particles, and nanosilica fine particles 114.

According to the second feature, in the resin composition as described in the first feature, the metal oxide fine particles are titanium dioxide fine particles 113.

According to the third feature, in the resin composition as described in the first feature, the metal oxide fine particles are titanium dioxide fine particles 113 with hydrophobic surface treatment.

According to the fourth feature, a laminate structure 1 includes a first layer 10 with silicone rubber as a base material, and a second layer 11 laminated to the first layer 10, which includes silicone rubber as a base material, silicone resin fine particles 112, metal oxide fine particles, and nanosilica fine particles 114.

According to the fifth feature, in the laminate structure 1 as described in the fourth feature, the metal oxide fine particles are titanium dioxide fine particles 113, and mass % concentration of the nanosilica fine particles 114 in the second layer 11 is 1.14 times or more than mass % concentration of Ti and 11.5 mass % or less.

According to the sixth feature, in the laminate structure 1 as described in the fifth feature, the Ti concentration in the second layer 11 is 1.0 mass % or more and 4.4 mass % or less.

According to the seventh feature, a cable 20 includes an insulator 23, 24 comprising the laminate structure 1 as described in any one of the fourth to sixth features.

According to the eighth feature, a tube 70a, 70b, 70c includes an insulator 72, 73, 74 comprising the laminate structure 1 described in any one of the fourth to sixth features.

According to the ninth feature, a method of manufacturing the resin composition includes adding nanosilica fine particles 114 to a mixture of silicone rubber, titanium dioxide fine particles 113, and an organic solvent, followed by adding silicone resin fine particles 112.

The invention is not limited to the above-described embodiments and examples, but can be varied and implemented in various ways within the scope that does not depart from the main purpose of the invention. The above-described embodiments and examples are not limiting the invention as per the claims. It should also be noted that not all of the combinations of features described in the embodiments and examples are essential to the means for solving the problems of the invention.

1. A resin composition, comprising:
silicone rubber as a base material, silicone resin fine particles, metal oxide fine particles, and nanosilica fine particles.

2. The resin composition, according to claim 1, wherein the metal oxide fine particles are titanium dioxide fine particles.

3. The resin composition, according to claim 1, wherein the metal oxide fine particles are titanium dioxide fine particles with hydrophobic surface treatment.

4. A laminate structure, comprising:
a first layer comprising silicone rubber as a base material; and
a second layer laminated to the first layer, the second layer comprising silicone rubber as a base material, silicone resin fine particles, metal oxide fine particles, and nanosilica fine particles.

5. The laminate structure, according to claim 4, wherein the metal oxide fine particles are titanium dioxide fine particles, and mass % concentration of the nanosilica fine particles in the second layer is 1.14 times or more than mass % concentration of Ti and 11.5 mass % or less.

6. The laminate structure, according to claim 5, wherein Ti concentration in the second layer is 1.0 mass % or more and 4.4 mass % or less.

7. A cable, comprising:
an insulator comprising the laminate structure according to claim 4.

8. A tube, comprising:
an insulator comprising the laminate structure according to claim 4.

9. A method of manufacturing a resin composition, comprising:
adding nanosilica fine particles to a mixture of silicone rubber, titanium dioxide fine particles, and an organic solvent, followed by adding silicone resin fine particles.
